(19) United States
(12) Patent Application Publication
(10) Pub. No.: US 2024/0427018 A1
(43) Pub. Date: Dec. 26, 2024

(54) DEPTH-EVENT CAMERA

(71) Applicant: QUALCOMM Incorporated, San Diego, CA (US)

(72) Inventors: Meng-Lin WU, San Diego, CA (US); Shusil DANGI, San Diego, CA (US); Kai HE, San Diego, CA (US); Chung-Chi TSAI, San Diego, CA (US)

(21) Appl. No.: 18/340,675

(22) Filed: Jun. 23, 2023

(51) Int. Cl. G01S 17/36; G01S 7/4914

(52) U.S. Cl. CPC G01S 17/36; G01S 7/4914

(57) ABSTRACT

Systems and techniques are described herein for determining changes in distance. For instance, an apparatus for determining changes in distance is provided. The apparatus may include an electromagnetic (EM)-radiation emitter configured to emit EM radiation toward an environment; a detector configured to receive reflected EM radiation from the environment; phase-calculation circuitry configured to calculate a phase-difference value indicative of a difference between a phase of the emitted EM radiation and a phase of the reflected EM radiation; and differencing circuitry configured to trigger an event responsive to a difference between a current phase-difference value and a prior phase-difference value exceeding a threshold.

### TECHNICAL FIELD

The present disclosure generally relates to a depth-event camera. For example, aspects of the present disclosure include systems and techniques for using the depth-event camera to detect changes in depth at points in an environment.

### BACKGROUND

An indirect time of flight (iToF) depth camera may emit a light pulse and receive the light pulse as reflected by various points in the environment. The iToF depth camera can calculate times of flight for the various points in the environment. The iToF depth camera may generate a depth information indicative of the distances between the iToF depth camera and various points of the environment.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described herein for determining changes in distance. According to at least one example, an apparatus for determining changes in distance is provided. The apparatus includes: an electromagnetic (EM)-radiation emitter configured to emit EM radiation toward an environment; a detector configured to receive reflected EM radiation from the environment; phase-calculation circuitry configured to calculate a phase-difference value indicative of a difference between a phase of the emitted EM radiation and a phase of the reflected EM radiation; and differencing circuitry configured to trigger an event responsive to a difference between a current phase-difference value and a prior phase-difference value exceeding a threshold.

Systems and techniques are described herein for determining changes in distance. According to at least one example, an apparatus for determining changes in distance is provided. The apparatus includes a memory and one or more processors coupled to the memory. The one or more processors are configured to: cause at least one electromagnetic (EM) emitter to emit first EM radiation toward an environment; responsive to receiving first reflected EM radiation from the environment, calculate a first phase-difference value indicative of a difference between a phase the first emitted EM radiation and a phase of the first reflected EM radiation; cause the at least one EM emitter to emit second EM radiation toward an environment; receiving second reflected EM radiation from the environment, calculate a second phase-difference value indicative of a difference between a phase the second emitted EM radiation and a phase of the second reflected EM radiation; and trigger an event responsive to a difference between the second phase-difference value and the first phase-difference value exceeding a threshold.

In another example, a method for determining changes in distance is provided. The method includes: emitting first electromagnetic (EM) radiation toward an environment; receiving first reflected EM radiation from the environment; calculating a first phase-difference value indicative of a difference between a phase the first emitted EM radiation and a phase of the first reflected EM radiation; emitting second EM radiation toward an environment; receiving second reflected EM radiation from the environment; calculating a second phase-difference value indicative of a difference between a phase the second emitted EM radiation and a phase of the second reflected EM radiation; and triggering an event responsive to a difference between the second phase-difference value and the first phase-difference value exceeding a threshold.

In another example, a non-transitory computer-readable medium is provided that has stored thereon instructions that, when executed by at least one processor, cause the at least one processor to: cause at least one electromagnetic (EM) emitter to emit first EM radiation toward an environment; responsive to receiving first reflected EM radiation from the environment, calculate a first phase-difference value indicative of a difference between a phase the first emitted EM radiation and a phase of the first reflected EM radiation; cause the at least one EM emitter to emit second EM radiation toward an environment; receiving second reflected EM radiation from the environment, calculate a second phase-difference value indicative of a difference between a phase the second emitted EM radiation and a phase of the second reflected EM radiation; and trigger an event responsive to a difference between the second phase-difference value and the first phase-difference value exceeding a threshold.

As another example, an apparatus for determining changes in distance is provided. The apparatus includes: means for emitting first electromagnetic (EM) radiation toward an environment; means for receiving first reflected EM radiation from the environment; means for calculating a first phase-difference value indicative of a difference between a phase the first emitted EM radiation and a phase of the first reflected EM radiation; means for emitting second EM radiation toward an environment; means for receiving second reflected EM radiation from the environment; means for calculating a second phase-difference value indicative of a difference between a phase the second emitted EM radiation and a phase of the second reflected EM radiation; and means for triggering an event responsive to a difference between the second phase-difference value and the first phase-difference value exceeding a threshold.

In some aspects, one or more of the apparatuses described herein is, can be part of, or can include a mobile device (e.g., a mobile telephone or so-called “smart phone”, a tablet computer, or other type of mobile device), an extended reality device (e.g., a virtual reality (VR) device, an augmented reality (AR) device, or a mixed reality (MR) device), a vehicle (or a computing device or system of a vehicle), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1A is a diagram illustrating a system including an apparatus which may detect changes in distance in environment, according to various aspects of the present disclosure.

FIG. 1B is a diagram including a perspective view of environment 116 and portions of apparatus 102 detecting changes in distance in environment 116, according to various aspects of the present disclosure.

FIG. 2 is a diagram illustrating an apparatus which may detect changes in distance in an environment, according to various aspects of the present disclosure.

FIG. 3 includes an image of a scene and a depth-event representation of the scene, according to various aspects of the present disclosure.

FIG. 4 includes: an image of objects on a specular surface and beside transparent surfaces, a representation of depth-change information corresponding to the image, and a representation of confidence values corresponding to the image.

FIG. 5 includes: an image of surfaces and edges of the surfaces, a representation of depth-change information corresponding to the image, and a representation of confidence values corresponding to the image.

FIG. 6 is a diagram illustrating a vehicle including a depth-event camera, according to various aspects of the present disclosure.

FIG. 7 is a flow diagram illustrating a process for determining changes in distance, in accordance with aspects of the present disclosure.

FIG. 8 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

An indirect Time-of-Flight (iToF) depth camera may measure phase differences between an emitted light pulse and the light pulse as received by the iToF depth camera after the light pulse has been reflected by points in the environment. The iToF depth camera may relate the phase differences to times-of-flight of the light pulse between emission and reception, based on the speed of light and the frequency of the light pulse. The iToF depth camera may, based on the time-of-flight and the speed of light, calculate distances between the iToF depth camera and points in the environment. In the present disclosure, the term “depth” may refer to a distance between a point in an environment and a detector of a sensor (e.g., an iToF depth camera). The iToF depth camera may determine depths for all points within a field of view of the iToF depth camera. For example, the iToF depth camera May include an array of detectors. Each of the detectors can correspond to a portion of the reflected EM radiation (e.g., a ray between the detector and the environment for example, based on reflected pulses being focused onto the array).

IToF depth cameras may take time to accumulate reflected light at the respective detectors. Further, iToF depth cameras may capture multiple pulses and average differences in phases across the multiple pulses. Further, iToF depth cameras may operate on a per-frame basis, for example, determining depths for all detectors of the iToF camera to generate a representation of depth measurements to points within a field of view of the iToF depth camera.

Systems, apparatuses, methods (also referred to as processes), and computer-readable media (collectively referred to herein as “systems and techniques”) are described herein for determining changes in distances. For example, the systems and techniques may be implemented in or by a depth-event camera. Such a depth-event camera may generate events, on a per-detector basis, when distances between the depth-event camera and points in the environment change.

In some aspects, the depth-event camera can include an electromagnetic (EM) radiation emitter configured to emit EM radiation toward an environment. In some cases, the EM radiation emitter can modulate (e.g., amplitude modulate) the EM radiation based on a reference modulating signal. For example, the EM radiation emitter may multiply a carrier signal (e.g., with a carrier frequency) with the reference modulating signal. The reference modulating signal may define an envelope of the EM radiation.

The depth-event camera can also include an array of detectors. Each detector of the array may correspond to a respective portion of the reflected EM radiation (e.g., a ray (in a particular direction) between the array and various points in the environment). For example, it may be possible to trace a respective ray from each detector of the array of detectors outward into the environment. In some cases, the systems and techniques may include a lens to focus reflected EM radiation from the environment onto the array. EM radiation from the environment propagating along a ray toward the lens may be focused by the lens onto a detector of the array of detectors.

The systems and techniques may include phase-calculation engines (e.g., circuitry). Each of the phase-calculation engines may be connected to a respective detector of the array of detectors. For example, a phase-calculation engine may calculate a phase-difference value indicative of a difference between a phase of the reference modulating signal and a phase of modulated EM radiation received at a detector connected to the phase-calculation engine.

In contrast to an iToF depth camera, the systems and techniques described herein may independently compare phase-difference values corresponding to each detector to determine whether a change in distance has occurred at a respective point in the environment corresponding to each detector. For example, the systems and techniques may include differencing engines (e.g., differencing circuitry). Each of the differencing engines may be connected to a respective phase-calculation engine. Each differencing engine may trigger an event responsive to a difference between a current phase-difference value and a prior phase-difference value exceeding a threshold. The array of detectors, phase-calculation engines, and differencing engines may independently and asynchronously detect and trigger events in response to changes in detected distances as the changes are detected. In some cases, the events may be output as a data stream.

As noted above, the depth-event camera can asynchronously trigger events on a per-detector basis, whereas an iToF depth camera operates on a per-frame basis. For instance, an iToF depth camera may capture depth-based representations of a scene, whereas the depth-event camera may trigger events, on a per-detector basis, based on changes in depth within a scene. For example, the systems and techniques may continuously emit EM radiation. If a depth of a point in a scene changes (e.g., based on something in the scene moving), a detector corresponding to that point may receive reflected EM radiation from that point. A corresponding phase-calculation engine may calculate a phase-difference value that is different from a prior phase-difference value for that point and a corresponding differencing engine may trigger an event based on the different phase-difference values. In some cases, the event may be correlated to the detector and independent of other detectors of the array of detectors. In some examples, the event may trigger once the differencing engine detects the difference between the prior phase-difference value and the most-recent phase-difference value.

In the present disclosure, the term “engine” may refer to circuitry, one or more circuits, logic, and/or operations performed by one or more processors and/or circuits. In the present disclosure, the term “circuitry” may refer to analog circuitry including one or more analog circuits and/or one or more analog circuit elements (e.g., resistors, capacitors, inductors, diodes, transistors and/or operational amplifiers) and/or digital circuitry including one or more digital circuits and/or circuit elements (e.g., transistors, logic gates, microcontrollers, and/or processors). In the present disclosure, the term “modulate,” unless stated otherwise, may refer to amplitude modulation of one signal (e.g., a carrier signal) by a modulating signal. Pulsing a signal may be an example of modulating the signal according to a square-wave modulating frequency. In the present disclosure, the terms “electromagnetic radiation,” “EM radiation,” and like terms may refer to electromagnetic radiation of any frequency including ultraviolet light, visible light, infrared light, and/or radio waves.

Various aspects of the application will be described with respect to the figures below.

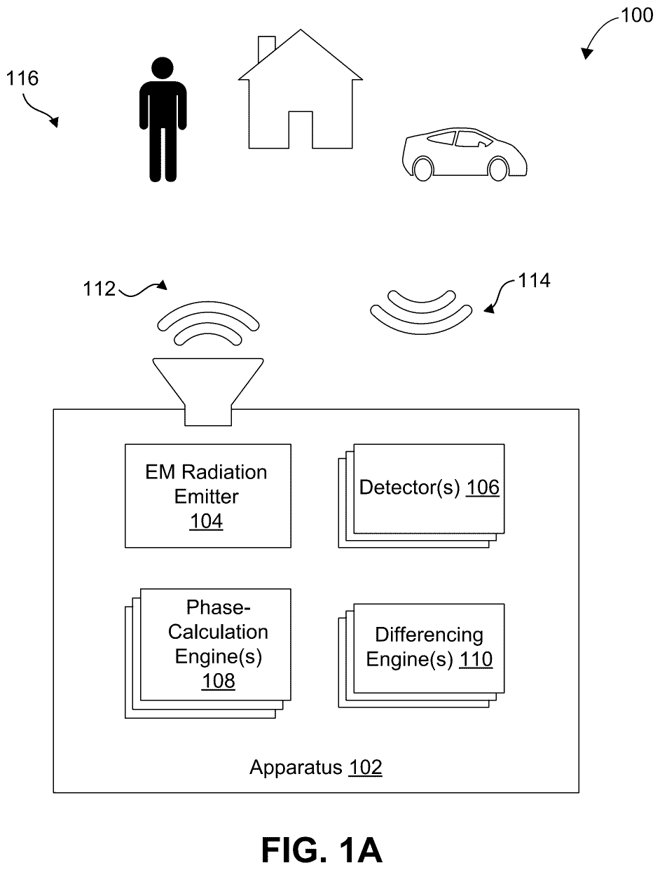

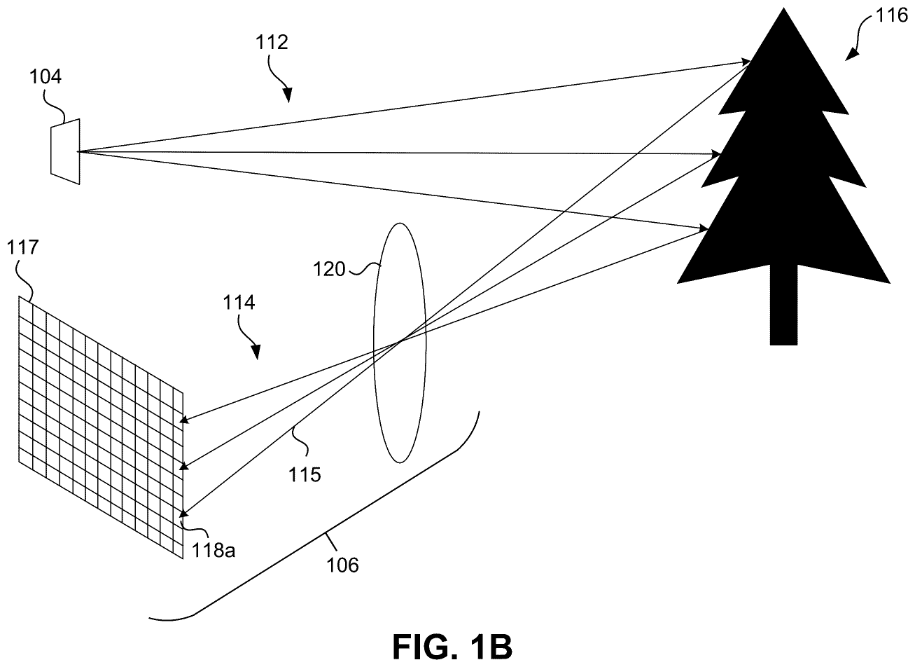

FIG. 1A is a diagram illustrating a system 100 including an apparatus 102 that can detect changes in distance in environment 116, according to various aspects of the present disclosure. FIG. 1B is a diagram including a perspective view of environment 116 and portions of apparatus 102 detecting changes in distance in environment 116, according to various aspects of the present disclosure. For example, apparatus 102 may be, may be part of, or may include, a depth-event camera.

As shown in FIG. 1A, apparatus 102 includes an electromagnetic (EM)-radiation emitter 104. As shown in FIG. 1B, EM-radiation emitter 104 may be configured to emit EM radiation 112 toward environment 116. EM-radiation emitter 104 can modulate EM radiation 112 according to a reference modulating signal. For example, in some cases, EM-radiation emitter 104 may modulate EM radiation 112 using one or more square waves. In some cases, EM-radiation emitter 104 may modulate EM radiation 112 according to a multi-phase modulation scheme (e.g., a four-phase modulation scheme). Additional details regarding a multi-phase modulation scheme are provided below.

As shown in FIG. 1A, apparatus 102 further includes one or more detector(s) 106. As shown in FIG. 1B, the one or more detector(s) 106 may be configured to receive EM radiation 114 from the environment. For example, EM radiation 112 may be reflected by objects in environment 116 and may return to be received and detected by detector(s) 106. Detector(s) 106 may include an array of detectors 117 (e.g., an array of independent detectors). Detector(s) 106 may include a lens 120 to direct EM radiation 114 associated with a given ray from environment 116 onto a corresponding detector of the array of detectors. For example, EM radiation 114 propagating along a ray 115 between environment 116 and lens 120 may be focused onto detector 118a of the array of detectors 118. Thus, each detector of the array of detectors may correspond to a ray from environment 116. For illustrative purposes, FIG. 1B is not drawn to scale. Additionally, unlike what is illustrated in FIG. 1B, the EM-radiation emitter 104 and detector(s) 106 may be positioned one beside the other.

As shown in FIG. 1A, apparatus 102 includes one or more phase-calculation engine(s) 108 (e.g., phase-calculation circuitry) configured to calculate a phase-difference value indicative of a difference between a phase the emitted EM radiation 112 and a phase of the reflected EM radiation 114. In some aspects, apparatus 102 can include a phase-calculation engine (from the phase calculation engine(s) 108) for each detector of the array of detectors. The phase-calculation engine(s) 108 may compare the phase of the envelopes and not the phase of the carrier signals. For example, EM-radiation emitter 104 may emit EM radiation 112 with a phase corresponding to a phase of the reference modulating signal (e.g., a square wave). A point in environment 116 may reflect EM radiation 114 back toward detector(s) 106. Detector(s) 106 may receive EM radiation 114. Between being emitted from EM-radiation emitter 104 and being received by detector(s) 106, the phase of the reference modulating signal may have advanced. However, the phase of the reflected EM radiation 114 may be aligned with the phase of the reference modulating signal when EM radiation 112 was emitted. Thus, a phase difference between the reference modulating signal and EM radiation 114 may be indicative of a time of flight of EM radiation 112 and EM radiation 114 between emission and reception.

As shown in FIG. 1A, apparatus 102 also includes one or more differencing engine(s) 110 (e.g., differencing circuitry) configured to trigger an event responsive to a difference between a current phase-difference value and a prior phase-difference value exceeding a threshold. In some cases, apparatus 102 may include one differencing engine of the differencing engine(s) 110 for each phase-calculation engine of the phase-calculation engine(s) 108 (as noted previously, each phase-calculation engine(s) 108 may correspond to one detector of the array of detectors). Phase-calculation engine(s) 108 may determine phase-difference values as EM radiation 114 is received. In some cases, phase-calculation engine(s) 108 may determine phase-difference values continuously. For example, EM-radiation emitter 104 may emit EM radiation 112 continuously, and detector(s) 106 may detect EM radiation 114 continuously (e.g., sensors of the detectors may be sampled at a sampling rate). Phase-calculation engine(s) 108 may compare the phase of EM radiation 112 (or of the reference modulating signal) to the phase of EM radiation 114 continuously (e.g., according to the sampling rate of the sensors). Differencing engine(s) 110 may compare prior phase-difference value to current phase-difference values (e.g., a most-recently-received phase-difference values) continuously (e.g., as soon as a current phase-difference value is received). For example, differencing engine(s) 110 may include a comparator that may hold a prior phase-difference value and compare the prior phase-difference value with a current phase-difference value.

Differencing engine(s) 110 may trigger an event each time a difference between the current phase-difference value and a prior phase-difference value exceeds a threshold. In some cases, phase-calculation engine(s) 108 and differencing engine(s) 110 may operate asynchronously. In such cases, by operating phase-calculation engine(s) 108 and differencing engine(s) 110 asynchronously, apparatus 102 may trigger events as distance changes are detected and not at a particular frame rate. Because in some cases differencing engine(s) 110 includes one differencing engine for each phase-calculation engine(s) 108, and one phase-calculation engine(s) 108 for each detector array of detectors, apparatus 102 may detect changes in distance on a per-detector basis.

In some cases, apparatus 102 may output events as a data stream (e.g., a variable bandwidth data stream). For example, the data stream may include events (e.g., in the form of tuples including position information and direction information). For example, the data stream may include an x-coordinate and a y-coordinate indicative of a position of the detector or of the environment corresponding to the event. Further the data stream may include an indication of direction corresponding to the event (e.g., an indication of the which threshold was crossed to trigger the event). For example, the data stream may include an indication of whether the event is responsive to a change based on something coming closer to the detector or by something in the environment moving farther away from the detector. Further, in some cases the data stream may include timestamps of events or another indication of when the event occurred.

In other cases, apparatus 102 may generate a depth-event map. The depth-event map may include a pixel corresponding to each detector. The depth-event map may include a representation of events triggered by each detector, for example, an event at a detector may correspond to a value of a pixel and a lack of events at a detector may correspond to a different value of a pixel. The depth-event map may be indicative of points in the environment for which a depth measurement changed between determining the prior phase-difference value and the current phase-difference value.

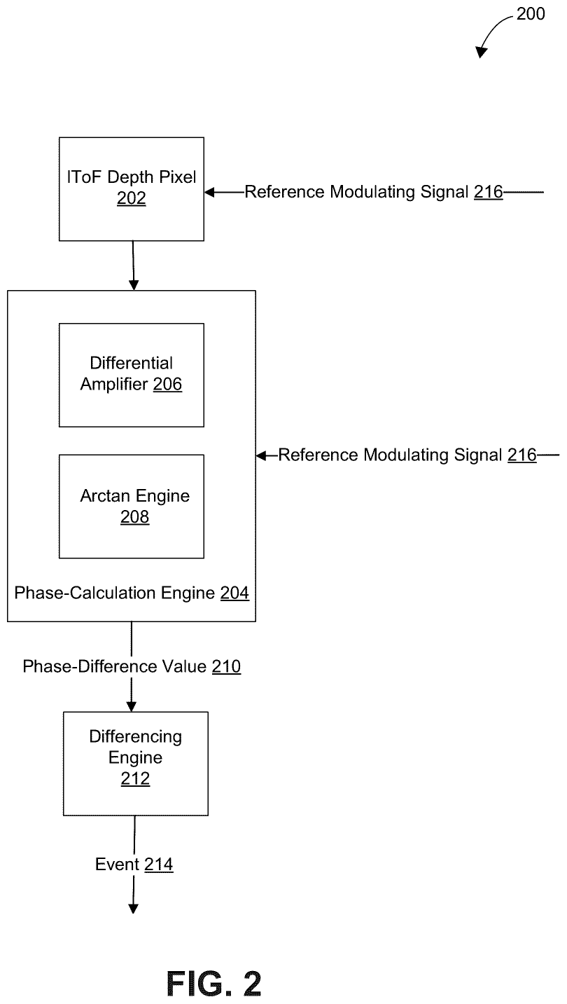

FIG. 2 is a diagram illustrating an apparatus 200 which may detect changes in distance in an environment, according to various aspects of the present disclosure. For example, apparatus 200 may be included in, a depth-event camera. Apparatus 200 may be an example of one detector, one phase-calculation engine (e.g., phase-calculation circuitry), and one differencing engine (e.g., differencing circuitry) of apparatus 102 of FIG. 1A.

In some aspects, apparatus 200 may include an EM radiation emitter (not illustrated in FIG. 2), such as EM-radiation emitter 104 of FIG. 1A and FIG. 1B. Apparatus 200 may modulate emitted EM radiation according to a reference modulating signal. For example, the EM radiation emitter may multiply a carrier signal (e.g., with a carrier frequency) with the reference modulating signal. The reference modulating signal may define an envelope of the EM radiation. In some cases, apparatus 200 may emit multiple modulated EM radiation signals modulated at different phases (e.g., according to a multi-phase modulation scheme). For example, iToF depth pixel 202 may emit four EM radiation signals including a first, a second 90 degrees behind the first, a third, 180 degrees behind the first, and a fourth 270 degrees behind the first. One or more of the reference modulating signals may be a square wave.

Apparatus 200 includes an iToF depth pixel 202. IToF depth pixel 202 may receive reflected EM radiation and provide indications of a phase of the received reflected EM radiation to phase-calculation engine 204 (e.g., phase-calculation circuitry). The phase may be a phase of the modulating signal (e.g., the envelope) and not the phase of the carrier signal. IToF depth pixel 202 may include a detector (such as one of detector(s) 106 of FIG. 1A and FIG. 1B).

Apparatus 200 includes a phase-calculation engine 204. Phase-calculation engine 204 may calculate a phase-difference value based on a difference between a phase of the emitted EM radiation and a phase of the reflected EM radiation received by iToF depth pixel 202. The phases may be phases of the modulating signals (e.g., the envelope of reference modulating signal and envelope of the reflected EM radiation) and not the phase of the carrier signals. For example, phase-calculation engine 204 may receive an indication of the phase of the reflected EM radiation from iToF depth pixel 202. Phase-calculation engine 204 may receive an indication of a phase of a reference modulating signal 216 (e.g., the reference modulating signal 216 used to modulate the EM radiation emitted by iToF depth pixel 202). Phase-calculation engine 204 may compare the phases to determine phase-difference value 210.

Phase-calculation engine 204 includes a differential amplifier 206. Differential amplifier 206 may amplify a voltage difference. The voltage difference may be indicative of a difference between a phase of the emitted EM radiation and a phase of the reflected EM radiation. For example, the voltage difference may be the difference between two voltages. Each voltage of the two voltages may be representative of the correlation between one of the four control signals (e.g., a reference signal) and the reflected signal. Each of the four control signals may have a different phase. Differential amplifier 206 may be an analog circuit. Differential amplifier 206 may include an amplifier and one or more resistors arranged such that the amplifier amplifies a difference between two input voltages.

Phase-calculation engine 204 includes an arctan engine 208. Arctan engine 208 may calculate a phase angle based on a difference between a phase of the emitted EM radiation and a phase of the reflected EM radiation. Arctan engine 208 may operate on the output of differential amplifier 206 (e.g., the amplified signal indicative of the difference between the phases of the emitted EM radiation and the reflected EM radiation). Arctan engine 208 may calculate the phase angle using a geometric function (e.g., an arctangent or equivalent thereof). Arctan engine 208 may perform demodulation, multiplication, inversion, addition, squaring, integration, filtering and/or buffering operations in determining the arctangent. Arctan engine 208 may be an analog circuit.

Phase-calculation engine 204 may generate phase-difference value 210. Phase-difference value 210 may be indicative of a phase difference between reflected EM radiation and emitted EM radiation. In one illustrative example, current phase-difference value 210 may be a phase angle.

Apparatus 200 includes differencing engine 212 (e.g., differencing circuitry). Differencing engine 212 may compare a current phase-difference value 210 with a prior phase-difference value 210. For example, differencing engine 212 received a current phase-difference value 210. Differencing engine 212 may compare the current phase-difference value 210 with a previously-received phase-difference value 210. In response to the difference between the current phase-difference value 210 and the previously-received phase-difference value 210 exceeding a threshold, differencing engine 212 may generate event 214. Further, differencing engine 212 may store the current phase-difference value 210 and compare the stored phase-difference value 210 with a subsequently received phase-difference value 210. For example, the current-phase difference value may become the previously-received difference value which may be compared with a new current phase-difference value. Differencing engine 212 may be an analog circuit. For example, differencing engine 212 may include a capacitor (e.g., to store phase-difference values 210), an inverter, and one or more comparators (e.g., to compare the difference between phase-difference values 210 to one or more thresholds).

In some cases, differencing engine 212 may compare the difference between phase-difference values 210 with multiple thresholds and trigger different events 214 based on which thresholds are exceeded. For example, differencing engine 212 may subtract the current phase-difference value 210 from the prior phase-difference value 210 and compare the difference with a greater positive threshold (indicative that the prior phase-difference value 210 was much greater than the current phase-difference value 210), a lesser positive threshold (indicative that the prior phase-difference value 210 was greater than the current phase-difference value 210), a lesser negative threshold (indicative that the current phase-difference value 210 was greater than the prior phase-difference value 210), and a greater negative threshold (indicative that the current phase-difference value 210 was much greater than the prior phase-difference value 210). If the difference exceeds the greater positive threshold, a greater positive event may be generated, if the difference exceeds the lesser positive threshold, a lesser positive event may be generated, if the difference exceeds the lesser negative threshold, a lesser negative event may be generated, if the difference exceeds the greater negative threshold, a greater negative event may be generated.

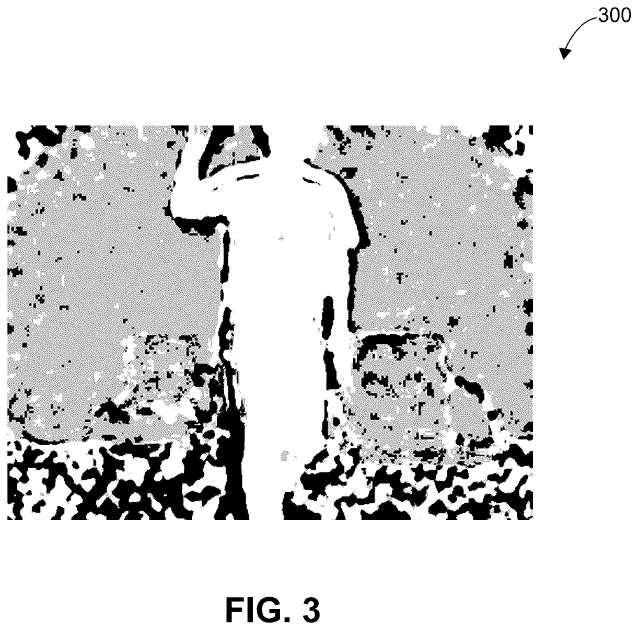

FIG. 3 includes a depth-event representation 300 of a scene, according to various aspects of the present disclosure. Depth-event representation 300 represents depth events (e.g., changes in depth over a duration of time) in the scene. Depth-event representation 300 is based on detectors that have detected changes in depth over the duration of time. For example, depth-event representation 300 includes one pixel corresponding to each detector of an array of detectors. For each detector that detected a depth increase over a duration of time, depth-event representation 300 includes a black pixel, for each detector that detected a depth decrease over the duration of time, depth-event representation 300 includes a white pixel, and for each detector that detected no change in depth over the duration of time, depth-event representation 300 includes a gray pixel. The scene includes a person that is moving toward the depth-event sensor and is thus mostly white. In depth-event representation 300, the floor is noisy (e.g., including white, black, and gray pixels), indicating depth uncertainty due to infrared (IR) absorption by carpet. For example, the carpet may randomly absorb or scatter the IR pulses which may be detected as random depth events. Depth-event representation 300 may be an example of a depth-event map.

The systems and techniques may generate depth events asynchronously (e.g., the systems and techniques may generate an event any time a depth changes). The systems and techniques may output the depth events as a data stream and not according to a duration of time. Because the events may be generated asynchronously, the duration of time may be a fraction of a frame rate of other sensors (e.g., cameras and/or iToF depth cameras). Depth-event representation 300 may be a representation of events generated over a duration of time (e.g., a duration of time specifically selected to generate depth-event representation 300). In some cases, the systems and techniques may not generate depth-event representations but rather output depth events in a data stream. Depth-event representation 300 may be generated by another system that may aggregate asynchronously generated events over a duration of time. Alternatively, in some cases, the systems and techniques may aggregate depth events over the duration of time and generate and/or output a depth-event representation.

In some cases, the systems and techniques may aggregate depth measurements over multiple discrete durations of time. In such cases, a depth-event representation may include pixel values representing multiple changes in the same direction over the multiple discrete durations of time. For example, for a detector that detected movement away from a detector 2 out of 2 durations of time, the depth-event representation may include a black pixel, for a detector that detected movement away from a detector 1 out of 2 durations of time, the depth-event representation may include a dark gray pixel, for a detector that detected no movement 2 out of 2 durations of time, the depth-event representation may include a gray pixel, for a detector that detected movement toward a detector 1 out of 2 durations of time, the depth-event representation may include a light gray pixel, and for a detector that detected movement toward a detector 2 out of 2 durations of time, the depth-event representation may include a white pixel.

Some iToF depth representations exhibit motion blur. For example, an iToF depth camera may determine depth information including depths of points in a scene (e.g., distances between the iToF depth camera and points in the scene). For example, an iToF depth camera may generate depth information at a frame rate (e.g., 30 frames per second (fps)). Such an iToF depth camera may integrate iToF depth information over time (e.g., according to the frame rate) to generate the depth information. For example, such an iToF depth camera may receive reflected EM radiation over duration (e.g., over 1/30th of a second) and integrate all phase difference values of all of reflected EM radiation received over the duration to generate a single depth value for the duration. However, objects in the scene may move during the duration. The movement may result in motion blur which may result in inaccurate depth information based on a point in the scene having two or more depths during the duration.

The systems and techniques may be used to deblur depth information. For example, the systems and techniques may be used with, or alongside, an iToF depth camera. Depth-change information generated by the systems and techniques may be used to correct motion blur in iToF depth information. For example, the systems and techniques may capture changes in depth at a fine temporal granularity (and/or asynchronously). Information based on the changes in depth may be used to resolve ambiguities in iToF depth information. For example, to correct motion blur, the systems and techniques may add up positive and negative depth events for a single pixel over a time period. For instance, the pixel may have moved closer by an amount exceeding a threshold N times during the time period. In this case, the systems and techniques do not ignore phase-difference values. Instead, the systems and techniques sample many phase-difference values, each with a very short integration time, and sum their contributions. In contrast, conventional iToF techniques may temporally average (e.g., over a long integration time, such as Q1˜Q4—phases of a four-phase modulation scheme) frames and output incorrect phase-difference values.

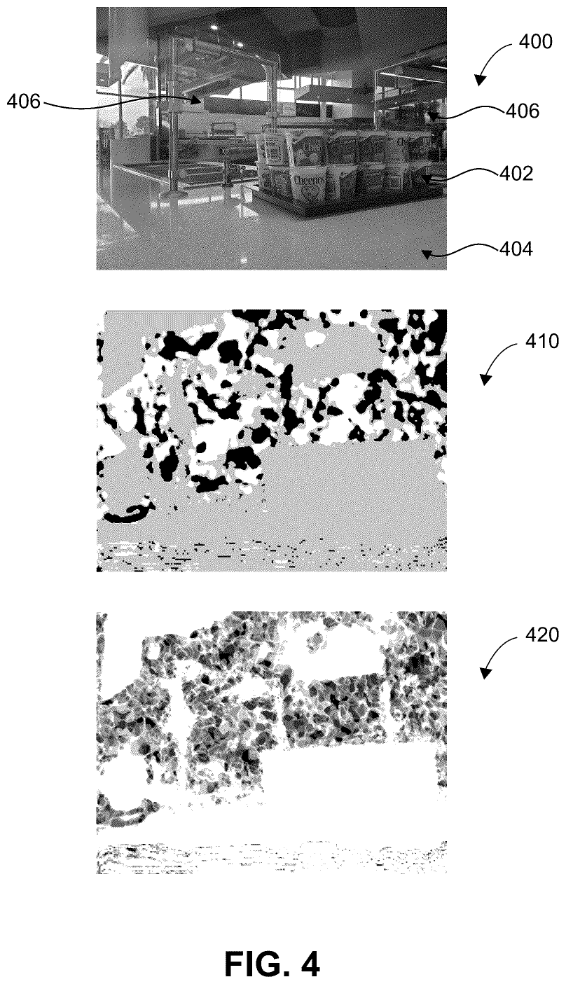

FIG. 4 includes an image 400 of objects 402 on a specular surface 404 and beside transparent surfaces 406. It may be difficult for an iToF depth camera to accurately determine depths of points of transparent surfaces and of specular surfaces. For example, specular or transparent surfaces may generate multiple reflections (e.g., multi-path reflections) that may arrive at different times (e.g., based on traversing different paths). Such reflections may be difficult for iToF depth cameras to distinguish. The systems and techniques may be used to generate confidence values related to depth information. For example, the systems and techniques may be used with, or alongside, an iToF depth camera to generate confidence values corresponding to depth information generated by the iToF depth camera.

For instance, a depth-event camera may be used to determine depth-change information based on a number of depth events. FIG. 4 includes a representation 410 of depth events generated over a period of time. Transparent surfaces 406 and specular surfaces 404 may generate a high rate of depth changes than objects 402. For example, transparent surfaces 406 and specular surface 404 may cause systems and techniques to generate depth events frequently. As such, in representation 410, objects 402 may appear gray (representing no depth events during the duration of time), while transparent surfaces 406 and specular surface 404 are represented with white and black (representing depth events indicative of movement closer to and farther from the depth-event camera). As one example, a depth-event camera may generate two events (indicating a change of depth) per iToF depth camera frame. The systems and techniques may determine a confidence value for each detector (and/or for each pixel of depth information of an iToF depth camera corresponding to the pixel) based on the depth change information. For example, FIG. 4 includes a representation 420 of confidence values corresponding to image 400. In representation 420, objects 402 appear as white indicating a high degree of confidence. Transparent surfaces 406 and specular surface 404 appear as gray and black indicating a low degree of confidence.

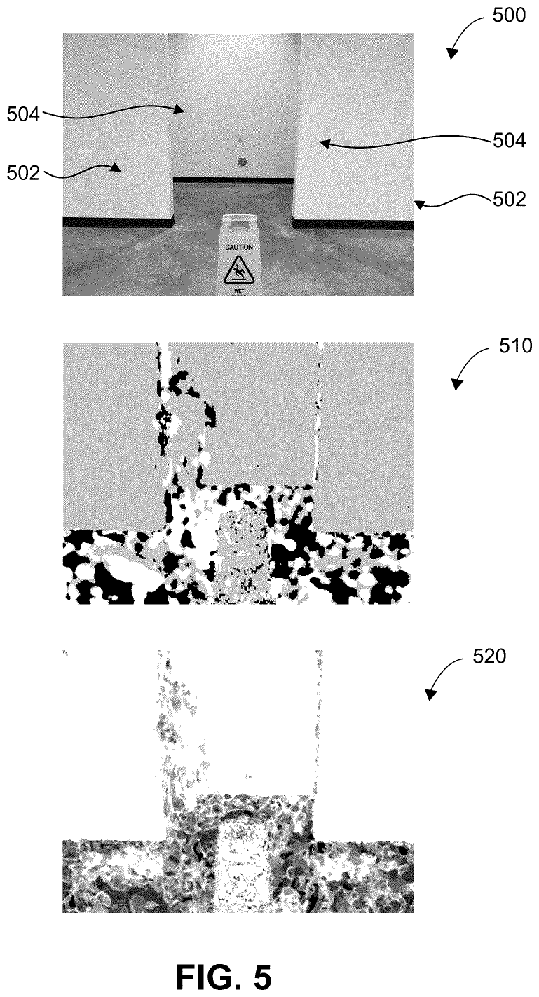

FIG. 5 includes image 500 of surfaces 502 and edges 504 of surfaces 502. It may be difficult for an iToF depth camera to accurately determine depths of points at edges of objects. For example, based on how emitted EM radiation is reflected, phase-difference values from a single point of an edge of an object may vary from a first time to a second time even if the distance has not changed. For example, a detector of the iToF depth camera may receive reflections from both a foreground surface and a background surface. The systems and techniques may be used to generate confidence values related to depth information. For example, the systems and techniques may be used with, or alongside, an iToF depth camera to generate confidence values corresponding to depth information generated by the iToF depth camera.

For instance, a depth-event camera may be used to determine depth-change information. FIG. 5 includes a representation 510 of depth events generated over a period of time. Points at edges 504 of surfaces 502 may generate depth changes frequently (e.g., edges 504 of surfaces 502 may cause systems and techniques to generate depth events frequently). As one example, a depth-event camera may generate two events (indicating a change of depth) at a point of edges 504 per iToF depth camera frame. The systems and techniques may determine a confidence value for each detector (and/or for each pixel of depth information of an iToF depth camera corresponding to the pixel) based on the depth-change information. For example, FIG. 5 includes a representation 520 of confidence values corresponding to image 500. In representation 520, surfaces 502 as white indicating a high degree of confidence. Edges 504 appear as gray and black indicating a low degree of confidence.

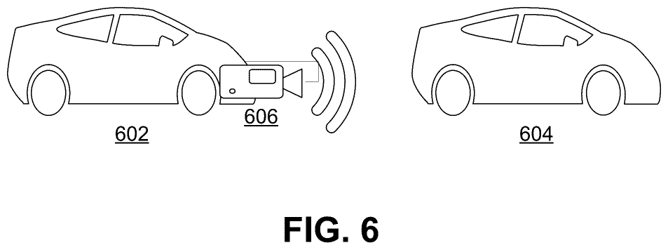

FIG. 6 is a diagram illustrating a vehicle 602 including a depth-event camera 606, according to various aspects of the present disclosure. For example, vehicle 602 may include a depth-event camera 606 that may be used to determine when changes of depths between vehicle 602 and various points in the environment of vehicle 602 change. There may be various uses for determining depth changes in an environment of a vehicle, a robot, a drone, or an automated machine. Vehicle 602 is given as an example. For example, depth changes may be used to determine a time to collision between vehicle 602 and an object in the environment (e.g., vehicle 604). As another example, depth changes may be used to determine how fast (or if) objects in the environment (e.g., vehicle 604) are moving. Determining changes in depth using a depth-event camera (e.g., apparatus 102 of FIG. 1, apparatus 200 of FIG. 2, and/or depth-event camera 606 of FIG. 6) may be superior to other techniques of determining depths and/or changes in depths at least because the depth-event camera 606 may be able to determine changes in depths asynchronously and/or more quickly than other techniques. For example, light detection and ranging (LIDAR) techniques may be used to determine depths to points in the environment. LIDAR scans may take more time to scan the environment than a depth-event camera takes to detect and report changes in the environment 606. Additionally, depth events (e.g., as generated by a depth-event camera) may be able to represent change in an environment with higher spatial and/or temporal resolution than LIDAR-based depth information. Further depth events, despite representing a higher spatial and/or temporal resolution than LIDAR-based depth information, may be communicated or stored using fewer bits of data. For example, depth events may represent all depth changes within a large field of view of the depth camera, asynchronously, in a data stream comprising tuples. In contrast, LIDAR-based depth information may comprise a value for each of a number of pixels. As another example, changes in depth may be determined by comparing sizes of objects in the environment in successive images captured by cameras. A depth-event camera (e.g., apparatus 102 of FIG. 1, apparatus 200 of FIG. 2, and/or depth-event camera 606 of FIG. 6) 606 may be able to determine changes in depth faster than image-comparison techniques are able to determine changes in depth.

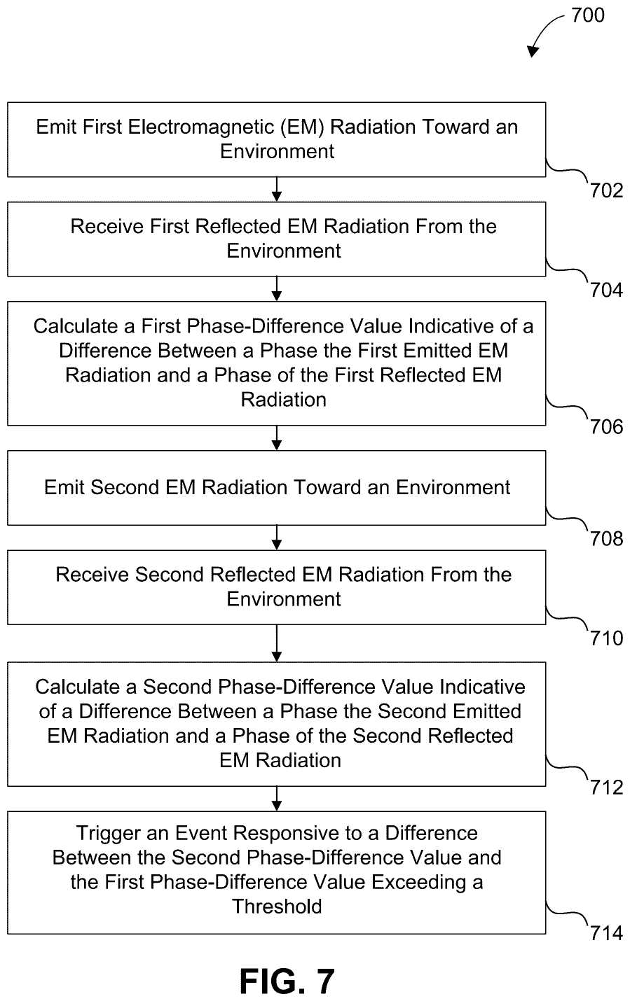

FIG. 7 is a flow diagram illustrating a process 700 for determining changes in distance, in accordance with aspects of the present disclosure. One or more operations of process 700 may be performed by a computing device (or apparatus) or a component (e.g., a chipset, codec, etc.) of the computing device. The computing device may be a vehicle or component or system of a vehicle, a mobile device (e.g., a mobile phone) or component or system of a mobile device, a network-connected wearable such as a watch or component or system of a wearable, an extended reality (XR) device such as a virtual reality (VR) device or augmented reality (AR) device or component or system of an XR device, a desktop computing device or component or system of a desktop computing device, a tablet computing device or component or system of a tablet computing device, a server computer or component or system of a server computer, a robotic device or component or system of a robotic device, and/or any other computing device with the resource capabilities to perform the process 700. The one or more operations of process 700 may be implemented as software components that are executed and run on one or more processors.

At block 702, the computing device (or one or more components thereof) may cause at least one electromagnetic (EM) radiation emitter to emit first EM radiation toward an environment. For example, EM-radiation emitter 104 of apparatus 102 may emit EM radiation 112 toward environment 116.

At block 704, the computing device (or one or more components thereof) may receive first reflected EM radiation from the environment. For example, detector(s) 106 of apparatus 102 may receive EM radiation 114 (e.g., first reflected EM radiation) reflected from environment 116.

At block 706, the computing device (or one or more components thereof) may calculate a first phase-difference value indicative of a difference between a phase the first emitted EM radiation and a phase of the first reflected EM radiation. For example, phase-calculation engine(s) 108 of apparatus 102 may calculate a phase-difference value (e.g., a first phase-difference value) indicative of a difference between a phase of EM radiation 112 and a phase of EM radiation 114. As another example, phase-calculation engine 204 of FIG. 2 may calculate current phase-difference value 210.

At block 708, the computing device (or one or more components thereof) may cause the at least one EM radiation emitter to emit second EM radiation toward an environment. For example, EM-radiation emitter 104 of apparatus 102 may emit EM radiation 112 toward environment 116.

At block 710, the computing device (or one or more components thereof) may receive second reflected EM radiation from the environment. For example, detector(s) 106 of apparatus 102 may receive EM radiation 114 (e.g., second reflected EM radiation) reflected from environment 116.

At block 712, the computing device (or one or more components thereof) may calculate a second phase-difference value indicative of a difference between a phase the second emitted EM radiation and a phase of the second reflected EM radiation. For example, phase-calculation engine(s) 108 of apparatus 102 may calculate a phase-difference value (e.g., a second phase-difference value) indicative of a difference between a phase of EM radiation 112 and a phase of EM radiation 114. As another example, phase-calculation engine 204 of FIG. 2 may calculate current phase-difference value 210.

At block 714, the computing device (or one or more components thereof) may trigger an event responsive to a difference between the second phase-difference value and the first phase-difference value exceeding a threshold. For example, differencing engine(s) 110 of apparatus 102 may trigger an event responsive to a difference between the second phase difference value (e.g., calculated at block 712) and the first phase difference value (e.g., calculated at block 706) exceeding a threshold. As another example, differencing engine 212 of FIG. 2 may trigger event 214 responsive to a difference between the second phase difference value 210 (e.g., calculated at block 712) and the first phase difference value 210 (e.g., calculated at block 706) exceeding a threshold.

In some aspects, receiving the first reflected EM radiation may be receiving the first reflected EM radiation at a detector of an array of detectors. The detector may correspond to a portion of the reflected EM radiation. Further, receiving the second reflected EM radiation may be receiving the second reflected EM radiation at the detector of the array of detectors. Further, the event may correspond to the detector of the array of detectors. For example, the first and second reflected radiation may propagate along ray 115 and may both be received by detector 118a. Detector 118a may be part of iToF depth pixel 202. Responsive to the first and second reflected radiation, apparatus 200 may generate event 214.

In some aspects, the detector of the array of detectors may be a first detector of the array of detectors and the event may be a first event. The computing device (or one or more components thereof) may receive third reflected EM radiation from the environment at a second detector of the array of detectors; calculate a third phase-difference value indicative of a difference between a phase the first emitted EM radiation and a phase of the third reflected EM radiation; receive fourth reflected EM radiation from the environment at the second detector of the array of detectors; calculating a fourth phase-difference value indicative of a difference between a phase the second emitted EM radiation and a phase of the fourth reflected EM radiation; and triggering a second event responsive to a difference between the fourth phase-difference value and the third phase-difference value exceeding a threshold. The second event may correspond to the second detector of the array of detectors. For example, detector(s) 106 of apparatus 102 may receive EM radiation 114 (e.g., third reflected radiation) reflected from environment 116. The third reflected radiation may be the first emitted EM radiation reflected. The third reflected radiation may be received by another detector of the array of detectors than the detector that received the first and second reflected radiation. Phase-calculation engine(s) 108 of apparatus 102 may calculate a phase-difference value indicative of a difference (e.g., a third phase-difference value) between a phase of EM radiation 112 and a phase of EM radiation 114. The phase-difference value between the third reflected EM radiation and the first emitted radiation may be calculated by another phase-calculation engine than was used to calculate the phase difference value between the first reflected EM radiation and the first emitted EM radiation. Detector(s) 106 of apparatus 102 may receive EM radiation 114 (e.g., fourth reflected radiation) reflected from environment 116. The fourth reflected radiation may be the second emitted EM radiation reflected. The fourth reflected radiation may be received by the detector of the array of detectors that received the third reflected radiation. Phase-calculation engine(s) 108 of apparatus 102 may calculate a phase-difference value indicative of a difference (e.g., a fourth phase-difference value) between a phase of EM radiation 112 and a phase of EM radiation 114. The phase-difference value between the fourth reflected EM radiation and the second emitted radiation may be calculated by the same phase-calculation engine than was used to calculate the phase difference value between the third reflected EM radiation and the first emitted EM radiation. Differencing engine(s) 110 of apparatus 102 may trigger an event (e.g., a second event) responsive to a difference between the fourth phase difference value and the third phase difference value exceeding a threshold. The second event may be triggered by another differencing engine than was used to trigger the first event. As another example, phase-calculation engine 204 of FIG. 2 may calculate current phase-difference value 210 (e.g., a third phase-difference value). Phase-calculation engine 204 of FIG. 2 may calculate current phase-difference value 210 (e.g., a fourth phase-difference value). Differencing engine 212 of FIG. 2 may trigger event 214 (e.g., a second event) responsive to a difference between the fourth phase difference value 210 and the third phase difference value 210 exceeding a threshold.

In some aspects, the first phase-difference value may be determined by a first phase-calculation engine (e.g., a first analog differential amplifier and a first analog arctangent-calculation circuit). The second phase-difference value may be determined by the first phase-calculation engine (e.g., the first analog differential amplifier and the first analog arctangent-calculation circuit). The third phase-difference value may be determined by a second phase-calculation engine (e.g., a second analog differential amplifier and a second analog arctangent-calculation circuit). The fourth phase-difference value may be determined by the second phase-calculation engine (e.g., the second analog differential amplifier and the second analog arctangent-calculation circuit). For example, the first and second reflected radiation may propagate along ray 115 and be received by detector 118a of an array of detectors 117. Detector 118a may be part of iToF depth pixel 202, which may be coupled to a phase-calculation engine 204 and a differencing engine 212 to generate an event 214. The third and fourth reflected radiation may propagate along another ray and be received by another detector of the array of detectors 117. The other detector may be part of another iToF depth pixel 202, which may be coupled to another phase-calculation engine 204 and another differencing engine 212 to generate another event 214.

In some aspects, the first phase-difference value may be calculated asynchronously and/or the second phase-difference value may be calculated asynchronously. For example, phase-calculation engine(s) 108 may operate asynchronously. As another example, phase-calculation engine 204 may operate asynchronously. In some aspects, the first phase-difference value may be determined by an analog phase-calculation engine (e.g., an analog differential amplifier and an analog arctangent-calculation circuit) and the second phase-difference value may be determined by the analog phase-calculation engine (e.g., the analog differential amplifier and the analog arctangent-calculation circuit). For example, phase-calculation engine 108 may be, or may include, one or more analog circuits. As another example, phase-calculation engine 204 may be, or may include, one or more analog circuits.

In some aspects, the computing device (or one or more components thereof) may asynchronously determine whether the difference between the second phase-difference value and the first phase-difference value exceeds the threshold. For example, differencing engine(s) 110 may operate asynchronously. As another example, differencing engine 212 may operate asynchronously. In some aspects, whether the difference between the second phase-difference value and the first phase-difference value exceeds the threshold may be determined by an analog differencing circuitry. For example, differencing engine(s) 110 may be, or may include, one or more analog circuits. As another example, differencing engine 212 may be, or may include one or more analog circuits.

In some aspects, whether the difference between the second phase-difference value and the first phase-difference value exceeds the threshold may be determined by a first differencing engine (e.g., a first analog differencing circuit). Whether the difference between the fourth phase-difference value and the third phase-difference value exceeds the threshold may be determined by a second differencing engine (e.g., a second analog circuit). For example, the first and second reflected radiation may propagate along ray 115 and be received by detector 118a of an array of detectors 117. Detector 118a may be part of iToF depth pixel 202, which may be coupled to a phase-calculation engine 204 and a differencing engine 212 to generate an event 214. The third and fourth reflected radiation may propagate along another ray and be received by another detector of the array of detectors 117. The other detector may be part of another iToF depth pixel 202, which may be coupled to another phase-calculation engine 204 and another differencing engine 212 to generate another event 214.

In some aspects, the computing device (or one or more components thereof) may generate and/or output a map indicative of the first event and the second event. The map may be indicative of points in the environment for which a depth measurement changed and/or a direction in which the depth measurements changed. For example, apparatus 102 may generate a map indicative of events. In some aspects, the computing device (or one or more components thereof) may generate and/or output a data stream indicative of the first event and the second event. The data stream may be indicative of points in the environment for which a depth measurement changed and/or a direction in which the depth measurements changed. For example, apparatus 102 may generate a data stream indicative of events.

In some aspects, the computing device (or one or more components thereof) may (or the computing device (or one or more components thereof) may cause the at least one emitter to modulate the first emitted EM radiation according to a reference modulating signal and modulate the second emitted EM radiation according to the reference modulating signal. Calculating the first phase-difference value may be based on a difference between a phase of the reference modulating signal and a phase of an envelope of the first reflected EM radiation. Calculating the second phase-difference value may be based on a difference between a phase of the reference modulating signal and a phase of an envelope of the second reflected EM radiation. For example, apparatus 102 may cause EM-radiation emitter 104 to modulate EM radiation 112 and phase-difference engine(s) 108 may determine the phase-difference values based on the envelope of EM radiation 114 (e.g., and not based on the carrier frequency). In some aspects, the modulating signal may be a square wave (e.g., such that EM radiation 112 is pulsed).

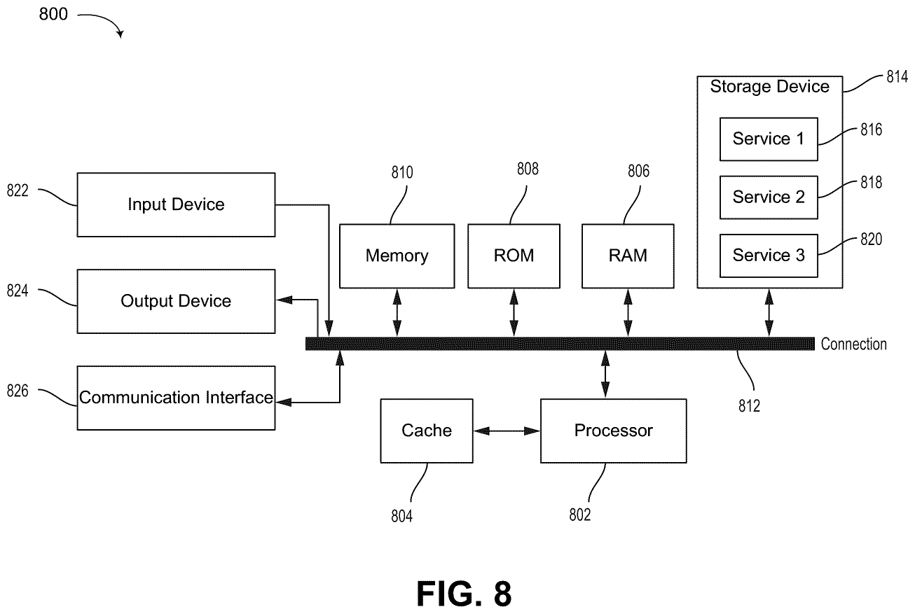

In some examples, as noted previously, the methods described herein (e.g., process 700 of FIG. 7, and/or other methods described herein) can be performed, in whole or in part, by a computing device or apparatus. In one example, one or more of the methods can be performed by apparatus 102 of FIG. 1A, apparatus 200 of FIG. 2, depth-event camera 606 of FIG. 6, or by another system or device. In another example, one or more of the methods (e.g., process 700 of FIG. 7, and/or other methods described herein) can be performed, in whole or in part, by the computing-device architecture 800 shown in FIG. 8. For instance, a computing device with the computing-device architecture 800 shown in FIG. 8 can include, or be included in, the components of the apparatus 102, apparatus 200, and/or depth-event camera 606 and can implement the operations of process 700, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 700 and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally process 700 and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 8 illustrates an example computing-device architecture 800 of an example computing device which can implement the various techniques described herein. In some examples, the computing device can include a vehicle (or computing device of a vehicle), a mobile device, a wearable device, an extended reality device (e.g., a virtual reality (VR) device, an augmented reality (AR) device, or a mixed reality (MR) device), a personal computer, a laptop computer, a video server, or other device. For example, the computing-device architecture 800 may include, implement, or be included in any or all of apparatus 102 of FIG. 1A, apparatus 200 of FIG. 2, depth-event camera 606 of FIG. 6.

The components of computing-device architecture 800 are shown in electrical communication with each other using connection 812, such as a bus. The example computing-device architecture 800 includes a processing unit (CPU or processor) 802 and computing device connection 812 that couples various computing device components including computing device memory 810, such as read only memory (ROM) 808 and random-access memory (RAM) 806, to processor 802.

Computing-device architecture 800 can include a cache of high-speed memory connected directly with, in close proximity to, or integrated as part of processor 802. Computing-device architecture 800 can copy data from memory 810 and/or the storage device 814 to cache 804 for quick access by processor 802. In this way, the cache can provide a performance boost that avoids processor 802 delays while waiting for data. These and other modules can control or be configured to control processor 802 to perform various actions. Other computing device memory 810 may be available for use as well. Memory 810 can include multiple different types of memory with different performance characteristics. Processor 802 can include any general-purpose processor and a hardware or software service, such as service 1 816, service 2 818, and service 3 820 stored in storage device 814, configured to control processor 802 as well as a special-purpose processor where software instructions are incorporated into the processor design. Processor 802 may be a self-contained system, containing multiple cores or processors, a bus, memory controller, cache, etc. A multi-core processor may be symmetric or asymmetric.

To enable user interaction with the computing-device architecture 800, input device 822 can represent any number of input mechanisms, such as a microphone for speech, a touch-sensitive screen for gesture or graphical input, keyboard, mouse, motion input, speech and so forth. Output device 824 can also be one or more of a number of output mechanisms known to those of skill in the art, such as a display, projector, television, speaker device, etc. In some instances, multimodal computing devices can enable a user to provide multiple types of input to communicate with computing-device architecture 800. Communication interface 826 can generally govern and manage the user input and computing device output. There is no restriction on operating on any particular hardware arrangement and therefore the basic features here may easily be substituted for improved hardware or firmware arrangements as they are developed.

Storage device 814 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 806, read only memory (ROM) 808, and hybrids thereof. Storage device 814 can include services 816, 818, and 820 for controlling processor 802. Other hardware or software modules are contemplated. Storage device 814 can be connected to the computing device connection 812. In one aspect, a hardware module that performs a particular function can include the software component stored in a computer-readable medium in connection with the necessary hardware components, such as processor 802, connection 812, output device 824, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“s”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Illustrative aspects of the disclosure include:

Aspect 1. An apparatus for determining changes in distance, the apparatus comprising: an electromagnetic (EM)-radiation emitter configured to emit EM radiation toward an environment; a detector configured to receive reflected EM radiation from the environment; phase-calculation circuitry configured to calculate a phase-difference value indicative of a difference between a phase of the emitted EM radiation and a phase of the reflected EM radiation; and differencing circuitry configured to trigger an event responsive to a difference between a current phase-difference value and a prior phase-difference value exceeding a threshold.

Aspect 2. The apparatus of aspect 1, wherein: the detector comprises an array of detectors; and each detector of the array of detectors corresponds to a respective portion of the reflected EM radiation.

Aspect 3. The apparatus of aspect 2, further comprising: a plurality of phase-calculation circuitries, wherein each phase-calculation circuitry of the plurality of phase-calculation circuitries is connected to a respective detector of the array of detectors, and wherein each phase-calculation circuitry of the plurality of phase-calculation circuitries is configured to calculate a respective phase-difference value indicative of a respective difference between the emitted EM radiation and a respective phase of reflected EM radiation received at a respective detector.

Aspect 4. The apparatus of aspect 3, further comprising: a plurality of differencing circuitries, wherein each differencing circuitry of the plurality of differencing circuitries is connected to a respective phase-calculation circuitry of the plurality of phase-calculation circuitries, and wherein each differencing circuitry of the plurality of differencing circuitries is configured to trigger an event responsive to a difference between a current phase-difference value and a prior phase-difference value exceeding a threshold.

Aspect 5. The apparatus of aspect 4, further comprising at least one processor configured to output a map indicative of events triggered by respective differencing circuitries of the plurality of differencing circuitries.

Aspect 6. The apparatus of aspect 5, wherein the map is indicative of points in the environment for which a depth measurement changed between determining the prior phase-difference value and the current phase-difference value.

Aspect 7. The apparatus of any one of aspects 4 to 6, wherein: the plurality of phase-calculation circuitries operate asynchronously; and the plurality of differencing circuitries operate asynchronously.

Aspect 8. The apparatus of any one of aspects 4 to 7, wherein the plurality of differencing circuitries are configured to output a data stream representative of the events.

Aspect 9. The apparatus of aspect 8, wherein the data stream comprises position information and direction information.

Aspect 10. The apparatus of any one of aspects 1 to 9, wherein the differencing circuitry is configured to output a data stream representative of the event.

Aspect 11. The apparatus of aspect 10, wherein the data stream comprises position information and direction information.

Aspect 12. The apparatus of any one of aspects 1 to 11, wherein: the EM-radiation emitter is further configured to modulate the emitted EM radiation based on a reference modulating signal; and the phase-difference value is indicative of a difference between a phase of the reference modulating signal and a phase of an envelope of the reflected EM radiation.

Aspect 13. The apparatus of aspect 12, wherein the reference modulating signal is a square wave.

Aspect 14. The apparatus of any one of aspects 1 to 13, wherein the phase-calculation circuitry comprises an analog differential amplifier and an analog arctangent-calculation circuitry.

Aspect 15. The apparatus of any one of aspects 1 to 14, wherein the differencing circuitry comprises an analog differencing circuitry.

Aspect 16. A method for determining changes in distance, the method comprising: emitting first electromagnetic (EM) radiation toward an environment; receiving first reflected EM radiation from the environment; calculating a first phase-difference value indicative of a difference between a phase the first emitted EM radiation and a phase of the first reflected EM radiation; emitting second EM radiation toward an environment; receiving second reflected EM radiation from the environment; calculating a second phase-difference value indicative of a difference between a phase the second emitted EM radiation and a phase of the second reflected EM radiation; and triggering an event responsive to a difference between the second phase-difference value and the first phase-difference value exceeding a threshold.

Aspect 17. The method of aspect 16, wherein: receiving the first reflected EM radiation comprises receiving the first reflected EM radiation at a detector of an array of detectors, the detector corresponding to a portion of the reflected EM radiation; receiving the second reflected EM radiation comprises receiving the second reflected EM radiation at the detector of the array of detectors; and the event corresponds to the detector of the array of detectors.

Aspect 18. The method of aspect 17, wherein: the detector of the array of detectors comprises a first detector of the array of detectors; the event comprises a first event; and the method further comprises: receiving third reflected EM radiation from the environment at a second detector of the array of detectors; calculating a third phase-difference value indicative of a difference between a phase the first emitted EM radiation and a phase of the third reflected EM radiation; receiving fourth reflected EM radiation from the environment at the second detector of the array of detectors; calculating a fourth phase-difference value indicative of a difference between a phase the second emitted EM radiation and a phase of the fourth reflected EM radiation; and triggering a second event responsive to a difference between the fourth phase-difference value and the third phase-difference value exceeding a threshold; and the second event corresponds to the second detector of the array of detectors.

Aspect 19. The method of aspect 18, wherein: the first phase-difference value is determined by a first analog differential amplifier and a first analog arctangent-calculation circuit; the second phase-difference value is determined by the first analog differential amplifier and the first analog arctangent-calculation circuit; the third phase-difference value is determined by a second analog differential amplifier and a second analog arctangent-calculation circuit; and the fourth phase-difference value is determined by the second analog differential amplifier and the second analog arctangent-calculation circuit.

Aspect 20. The method of any one of aspects 16 to 18, wherein: whether the difference between the second phase-difference value and the first phase-difference value exceeds the threshold is determined by a first analog differencing circuitry; and whether the difference between the fourth phase-difference value and the third phase-difference value exceeds the threshold is determined by a second analog differencing circuitry.

Aspect 21. The method of any one of aspects 16 to 20, further comprising outputting a map indicative of the first event and the second event.

Aspect 22. The method of aspect 21, wherein the map is indicative of points in the environment for which a depth measurement changed and a direction in which the depth measurements changed.

Aspect 23. The method of any one of aspects 18 to 22, further comprising outputting a data stream indicative of the first event and the second event.

Aspect 24. The method of aspect 23, wherein the data stream is indicative of points in the environment for which a depth measurement changed and a direction in which the depth measurements changed.

Aspect 25. The method of any one of aspects 16 to 24, further comprising: modulating the first emitted EM radiation according to a reference modulating signal; and modulating the second emitted EM radiation according to the reference modulating signal; wherein calculating the first phase-difference value is based on a difference between a phase of the reference modulating signal and a phase of an envelope of the first reflected EM radiation; and wherein calculating the second phase-difference value is based on a difference between a phase of the reference modulating signal and a phase of an envelope of the second reflected EM radiation.

Aspect 26. The method of aspect 25, wherein the reference modulating signal is a square wave.

Aspect 27. The method of any one of aspects 16 to 26, wherein the first phase-difference value is calculated asynchronously and the second phase-difference value is calculated asynchronously.

Aspect 28. The method of any one of aspects 16 to 27, wherein: the first phase-difference value is determined by an analog differential amplifier and an analog arctangent-calculation circuit; and the second phase-difference value is determined by the analog differential amplifier and the analog arctangent-calculation circuit.

Aspect 29. The method of any one of aspects 16 to 28, further comprising asynchronously determining whether the difference between the second phase-difference value and the first phase-difference value exceeds the threshold.

Aspect 30. The method of any one of aspects 16 to 29, wherein whether the difference between the second phase-difference value and the first phase-difference value exceeds the threshold is determined by an analog differencing circuitry.

What is claimed is:

1. An apparatus for determining changes in distance, the apparatus comprising:
an electromagnetic (EM)-radiation emitter configured to emit EM radiation toward an environment;
a detector configured to receive reflected EM radiation from the environment;
phase-calculation circuitry configured to calculate a phase-difference value indicative of a difference between a phase of the emitted EM radiation and a phase of the reflected EM radiation; and
differencing circuitry configured to trigger an event responsive to a difference between a current phase-difference value and a prior phase-difference value exceeding a threshold.

2. The apparatus of claim 1, wherein:
the detector comprises an array of detectors; and
each detector of the array of detectors corresponds to a respective portion of the reflected EM radiation.

3. The apparatus of claim 2, further comprising:
a plurality of phase-calculation circuitries, wherein each phase-calculation circuitry of the plurality of phase-calculation circuitries is connected to a respective detector of the array of detectors, and wherein each phase-calculation circuitry of the plurality of phase-calculation circuitries is configured to calculate a respective phase-difference value indicative of a respective difference between the emitted EM radiation and a respective phase of reflected EM radiation received at a respective detector.

4. The apparatus of claim 3, further comprising:
a plurality of differencing circuitries, wherein each differencing circuitry of the plurality of differencing circuitries is connected to a respective phase-calculation circuitry of the plurality of phase-calculation circuitries, and wherein each differencing circuitry of the plurality of differencing circuitries is configured to trigger an event responsive to a difference between a current phase-difference value and a prior phase-difference value exceeding a threshold.

5. The apparatus of claim 4, further comprising at least one processor configured to output a map indicative of events triggered by respective differencing circuitries of the plurality of differencing circuitries.

6. The apparatus of claim 5, wherein the map is indicative of points in the environment for which a depth measurement changed between determining the prior phase-difference value and the current phase-difference value.

7. The apparatus of claim 4, wherein:
the plurality of phase-calculation circuitries operate asynchronously; and
the plurality of differencing circuitries operate asynchronously.

8. The apparatus of claim 4, wherein the plurality of differencing circuitries are configured to output a data stream representative of the events.

9. The apparatus of claim 8, wherein the data stream comprises position information and direction information.

10. The apparatus of claim 1, wherein the differencing circuitry is configured to output a data stream representative of the event.

11. The apparatus of claim 10, wherein the data stream comprises position information and direction information.

12. The apparatus of claim 1, wherein:
the EM-radiation emitter is further configured to modulate the emitted EM radiation based on a reference modulating signal; and
the phase-difference value is indicative of a difference between a phase of the reference modulating signal and a phase of an envelope of the reflected EM radiation.

13. The apparatus of claim 12, wherein the reference modulating signal is a square wave.

14. The apparatus of claim 1, wherein the phase-calculation circuitry comprises an analog differential amplifier and an analog arctangent-calculation circuitry.

15. The apparatus of claim 1, wherein the differencing circuitry comprises an analog differencing circuitry.

16. A method for determining changes in distance, the method comprising:
emitting first electromagnetic (EM) radiation toward an environment;
receiving first reflected EM radiation from the environment;
calculating a first phase-difference value indicative of a difference between a phase the first emitted EM radiation and a phase of the first reflected EM radiation;
emitting second EM radiation toward an environment;
receiving second reflected EM radiation from the environment;
calculating a second phase-difference value indicative of a difference between a phase the second emitted EM radiation and a phase of the second reflected EM radiation; and
triggering an event responsive to a difference between the second phase-difference value and the first phase-difference value exceeding a threshold.

17. The method of claim 16, wherein:
receiving the first reflected EM radiation comprises receiving the first reflected EM radiation at a detector of an array of detectors, the detector corresponding to a portion of the first reflected EM radiation;
receiving the second reflected EM radiation comprises receiving the second reflected EM radiation at the detector of the array of detectors; and
the event corresponds to the detector of the array of detectors.

18. The method of claim 17, wherein:
the detector of the array of detectors comprises a first detector of the array of detectors;
the event comprises a first event; and
the method further comprises:
receiving third reflected EM radiation from the environment at a second detector of the array of detectors;
calculating a third phase-difference value indicative of a difference between a phase the first emitted EM radiation and a phase of the third reflected EM radiation;
receiving fourth reflected EM radiation from the environment at the second detector of the array of detectors;
calculating a fourth phase-difference value indicative of a difference between a phase the second emitted EM radiation and a phase of the fourth reflected EM radiation; and
triggering a second event responsive to a difference between the fourth phase-difference value and the third phase-difference value exceeding a threshold; and
the second event corresponds to the second detector of the array of detectors.

19. The method of claim 18, wherein:
the first phase-difference value is determined by a first analog differential amplifier and a first analog arctangent-calculation circuit;
the second phase-difference value is determined by the first analog differential amplifier and the first analog arctangent-calculation circuit;
the third phase-difference value is determined by a second analog differential amplifier and a second analog arctangent-calculation circuit; and
the fourth phase-difference value is determined by the second analog differential amplifier and the second analog arctangent-calculation circuit.

20. The method of claim 18, wherein:
whether the difference between the second phase-difference value and the first phase-difference value exceeds the threshold is determined by a first analog differencing circuitry; and
whether the difference between the fourth phase-difference value and the third phase-difference value exceeds the threshold is determined by a second analog differencing circuitry.

21. The method of claim 18, further comprising outputting a map indicative of the first event and the second event.

22. The method of claim 21, wherein the map is indicative of points in the environment for which a depth measurement changed and a direction in which the depth measurement changed.

23. The method of claim 18, further comprising outputting a data stream indicative of the first event and the second event.

24. The method of claim 23, wherein the data stream is indicative of points in the environment for which a depth measurement changed and a direction in which the depth measurement changed.

25. The method of claim 16, further comprising:
modulating the first emitted EM radiation according to a reference modulating signal; and
modulating the second emitted EM radiation according to the reference modulating signal;
wherein calculating the first phase-difference value is based on a difference between a phase of the reference modulating signal and a phase of an envelope of the first reflected EM radiation; and
wherein calculating the second phase-difference value is based on a difference between a phase of the reference modulating signal and a phase of an envelope of the second reflected EM radiation.

26. The method of claim 25, wherein the reference modulating signal is a square wave.

27. The method of claim 16, wherein the first phase-difference value is calculated asynchronously and the second phase-difference value is calculated asynchronously.

28. The method of claim 16, wherein:
the first phase-difference value is determined by an analog differential amplifier and an analog arctangent-calculation circuit; and
the second phase-difference value is determined by the analog differential amplifier and the analog arctangent-calculation circuit.

29. The method of claim 16, further comprising asynchronously determining whether the difference between the second phase-difference value and the first phase-difference value exceeds the threshold.

30. The method of claim 16, wherein whether the difference between the second phase-difference value and the first phase-difference value exceeds the threshold is determined by an analog differencing circuitry.
